(19) United States
(12) Patent Application Publication
(10) Pub. No.: US 2026/0318447 A1
(43) Pub. Date: Oct. 15, 2026

(54) PERMEATION-BARRIER AND METHOD OF MANUFACTURE

(71) Applicant: Baker Hughes Energy Technology UK Limited, Bristol (GB)

(72) Inventors: Fabio De Souza PIRES, Newcastle-Upon-Tyne Tyne and Wear (GB); Andre Leao MACEDO, Newcastle-Upon-Tyne Tyne and Wear (GB); Richard Alasdair CLEMENTS, Newcastle-Upon-Tyne Tyne and Wear (GB); Andrew Peter ROBERTS, Newcastle-Upon-Tyne Tyne and Wear (GB); Garry Ian KENDALL, Newcastle-Upon-Tyne Tyne and Wear (GB)

(21) Appl. No.: 18/998,635

(22) PCT Filed: Jul. 28, 2023
(86) PCT No.: PCT/EP2023/025356

§ 371 Date: Jan. 27, 2025

(30) Foreign Application Priority Data
Jul. 29, 2022 (GB) 2211147.0

(51) Int. Cl. F16L 11/08; F16L 11/04

(52) U.S. Cl. CPC F16L 11/083; F16L 2011/047

(57) ABSTRACT

A flexible pipe body for transporting production fluids, flexible riser and method of manufacturing a flexible pipe body are disclosed. The flexible pipe body comprises: an internal pressure sheath; a permeation-barrier for reducing fluid permeation of the production fluids towards a pipe annulus; a metallic armour layer positioned radially outward of the permeation-barrier; and a composite tape layer comprising a plurality of fibres, wherein the composite tape layer is positioned radially between the permeation-barrier and the metallic armour layer.

### TECHNICAL FIELD

The present invention relates to a flexible pipe body including a permeation-barrier and a method of manufacturing said flexible pipe body. In particular, but not exclusively, the present invention relates to a permeation-barrier for reducing fluid permeation into a pipe annulus.

### BACKGROUND

Flexible pipe is particularly useful in connecting a sub-sea location (which may be deep underwater) to a sea level location. The pipe may have an internal diameter of typically up to around 0.6 metres (e.g. diameters may range from 0.05 m up to 0.6 m). Flexible pipe is generally formed as an assembly of a flexible pipe body and one or more end fittings. The flexible pipe body is typically formed as a combination of layered materials that form a pressure-containing conduit. The pipe structure allows large deflections without causing bending stresses that impair the pipe's functionality over its lifetime. The flexible pipe body is generally built up as a combined structure including polymer, and/or metallic, and/or composite layers. For example, a flexible pipe body may include polymer and metal layers, or polymer and composite layers, or polymer, metal and composite layers.

API Recommended Practice 17B provides guidelines for the design, analysis, manufacture, testing, installation, and operation of flexible pipes and flexible pipe systems for onshore, subsea and marine applications. API Specification 17J titled “Specification for Unbonded Flexible Pipe” defines the technical requirements for safe, dimensionally and functionally interchangeable flexible pipes that are designed and manufactured to uniform standards and criteria.

Flexible pipe body typically includes a fluid-retaining layer (known as a barrier layer or liner) formed generally as a polymer sheath or pressure sheath. Such a layer operates as a primary fluid retaining layer. To prevent rupture of such a layer caused by the pressure of the transported fluid, an interlocked wire layer (known as a pressure armour layer) is often located radially outwards of the fluid-retaining layer. A typical flexible pipe body includes one or more armour layers, optionally including a pressure armour layer. The primary load on such layers is formed from radial forces. Pressure armour layers often have a specific cross-sectional profile to interlock so as to be able to maintain and absorb radial forces resulting from outer or inner pressure on the pipe. The cross-sectional profile of the wound wires which thus prevent the pipe from collapsing or bursting as a result of pressure are sometimes called pressure-resistant profiles. When armour layers are formed from helically wound wires forming hoop components, the radial forces from inner or outer pressure on the pipe cause the hoop components to expand or contract, putting respectively tensile or compressive loads on the wires.

Certain known examples of pressure armour layers may be provided as a tape or composite tape form, wrapped or wound around radially inward layers. The tape has a thickness to provide sufficient hoop strength to the flexible pipe body. Furthermore, the tape is orientated to ensure its longitudinal strength is arranged circumferentially, or substantially circumferentially around the axis of the flexible pipe body. Thus, the tape is wrapped or wound with a lay angle relative to the axis of between 80° and 90° to provide a pressure armour layer formed from tape. In these ways a tape, or a composite tape, that forms a pressure armour layer which is able to maintain and absorb radial forces resulting from pressure in the pipe.

One or more tensile armour layers may be positioned radially outward of a pressure armour layer(s). Tensile armour is used to sustain tensile loads and internal pressure. The tensile armour layer is often formed from a plurality of wires (to impart strength to the layer) that are located over an inner layer and are helically wound along the length of the pipe. The tensile armour layers are often metallic layers, formed from carbon steel, for example. The tensile armour layers may alternatively be composite tendons, of a matrix material reinforced with suitable fibres, for instance of glass, carbon, aramid, basalt, or metal.

Flexible pipe is utilised to transport production fluids, such as oil and/or gas and/or water, from one location to another. As used herein “fluid” includes both liquid and gases substances. When a production fluid is conveyed through a flexible pipe, fluids such as carbon dioxide and hydrogen sulphide gases, for example, can permeate the inner most layers of the flexible pipe body (for example the internal pressure sheath).

As used herein, permeation, particularly permeation of a fluid through a layer of a flexible pipe, may include both transmission of the fluid through a body of the layer as well as leakage of the fluid through discontinuities or gaps in the layer, the particular meaning being readily apparent from the context of the accompanying description.

These fluids then accumulate in the pipe annulus. This may result in a corrosive environment, in particular when associated with water present in the annulus, for example during an annulus flooding event. The corrosive environment is known to lead to pipe failure due to stress corrosion cracking of the metallic pipe layers, particularly those metallic layers used within armour layers. Furthermore, a build-up of annulus fluids can cause over pressurization and mechanical failure of the flexible pipe.

Certain known examples of a flexible pipe body provide a permeation-barrier, also known as a fill layer, radially outward of the internal pressure sheath. The permeation-barrier is typically configured as a barrier to fluid, that is production fluid, which permeates through the internal pressure sheath due to the internal pressure therein.

A problem of certain flexible pipe bodies is that permeation-barriers do not have sufficient mechanical strength. In particular, permeation-barriers are unable to withstand non-uniform and locallised layer strains resulting from the internal pressure urging pipe layer materials into gaps in over-lying pipe layers, leading to localised mechanical damage of the permeation-barrier during operation. Mechanical damage of the permeation-barrier increases the risk of the permeation-barrier being breached by fluids during use, or at least increasing permeation past the permeation-barrier layer.

A further problem is that a permeation-barrier may be damaged by contact with, or the geometry of, the armour layer positioned radially outward thereof. Such contact or geometry causes damage to the permeation-barrier during manufacture and/or causes damage due to interfacial pressure forcing the permeation-barrier against the armour layer. In particular, the permeation-barrier may thereby be damaged by interfacial pressure against the uneven opposing inner surfaces of the over-lying armour layer.

Metal permeation barriers are well known (for instance metallic barriers described in ASTM B479), and for pipelines the British Standard BS 8588 describes polyethylene pipes with an aluminium barrier layer incorporated, however for the reasons described above, such permeation-barriers may not be suitable in the context of high pressure flexible pipes where helical metallic armour layers are applied to withstand the internal fluid pressure in the flexible pipe.

It is an aim of certain examples of the present invention to solve, mitigate or obviate, at least partly, at least one of the problems and/or disadvantages associated with the prior art. Certain examples aim to provide at least one of the advantages described below.

### SUMMARY OF INVENTION

The invention is set out in the appended claims.

According to a first aspect, there is provided a flexible pipe body for transporting production fluids, the flexible pipe body including:
an internal pressure sheath;
a permeation-barrier for reducing fluid permeation of the production fluids to the pipe annulus;
a metallic armour layer positioned radially outward of the permeation-barrier; and
a composite tape layer including a plurality of fibres,
wherein the composite tape layer is positioned radially between the permeation-barrier and the metallic armour layer.

By providing a metallic armour layer and an additional composite tape layer to support the permeation-barrier, permeation of the undesirable fluids from the production fluids to the pipe annulus, typically by transmission, is thereby further reduced or even prevented. Permeation is prevented while ensuring reliability and integrity of the permeation-barrier.

It is known that a permeation-barrier may comprise a metal tape or foil, and the permeation through a metal is extremely low, and therefore the permeation which does occur is essentially fluid leakage between and around such permeation barrier layer tape wraps. Similarly polymer tapes or films comprising material with very low permeability properties, for instance PEEK, PEKK or ethylene-vinyl alcohol copolymer (EVOH), or similar, are known and may be used in a permeation barrier layer. The performance of a permeation-barrier layer comprising barrier tapes, films or foils may be optimised by reducing the thickness of the tapes and increasing the number of layers of the tapes, ensuring overlap of tape wraps to increase the tortuosity of the path through which the fluid must pass to get through the permeation barrier layer. By providing an additional composite tape layer to support the permeation-barrier, the permeation-barrier is protected from strain damage, and in addition permeation of undesirable fluids which do migrate through the permeation-barrier layer must further negotiate a tortuous permeation path through the composite tape layer, further limiting the exposure of the metallic armour layer(s) in the pipe body to the undesirable fluids.

Suitably, the permeation-barrier tape, film or foil may be of thickness between 0.00001 mm and 1.0 mm. Suitably, the permeation-barrier tape, film or foil may be of thickness between 0.005 mm and 0.5 mm. Suitably, the permeation-barrier tape, film or foil may be of thickness between 0.01 mm and 0.5 mm. The composite tape layer is thereby configured to provide optimal support and wear resistance in a convenient and adaptable manner, without providing the predominant hoop strength of a flexible pipe body. The composite tape layer thereby further provides additional permeation resistance to acidic gas species.

Suitably, the composite tape layer is positioned radially inward of and directly adjacent to the helically wound metallic armour layer.

Suitably, the permeation-barrier includes a helically wound tape or a film.

Suitably, the helically wound tape of the permeation-barrier includes a lay angle relative to an axis of the flexible pipe body in a range from greater than 20° to less than 80°.

Suitably, the helically wound tape or the film of the permeation-barrier includes a metal.

Suitably, the metallic armour layer includes at least one helically wound metallic tape having a first longitudinal edge and a second longitudinal edge, and wherein the metallic armour layer includes a region of overlap coextending with the first longitudinal edge of a first tape wrap of the helically wound metallic tape and the second longitudinal edge of a second tape wrap. In this way, the region of overlap is a helical region of overlap.

Suitably, the composite tape layer is configured to cover the region of overlap between laterally adjacent tape wraps of a radially adjacent metallic armour layer. Typically, laterally adjacent tape wraps of the composite tape are provided with the same lay angle. The overlaps may therefore reduce permeation of fluid through the composite tape layer by reducing or removing gaps between adjacent tape wraps. Particularly, leakage of fluid via discontinuities between laterally adjacent tape wraps, or between radially adjacent sub-layers of tape wraps is thereby reduced.

Suitably, the helically wound metallic armour layer is a pressure armour layer or a tensile armour layer.

Suitably, the metallic armour layer is a pressure armour layer with a lay angle relative to an axis of the flexible pipe body of at least 80°.

Suitably, the composite tape layer includes helically wound composite tape with a lay angle relative to the flexible pipe axis in a range from greater than 20° to less than 80°.

Suitably, the composite tape layer and the permeation-barrier are at least partially bonded to one another. In this way, a composite tape layer backing to the permeation-barrier is provided.

Suitably, the composite tape layer and the permeation-barrier are at least partially bonded to one another using an adhesive.

Suitably, the composite tape layer and the permeation-barrier are at least partially bonded to one another using a melt consolidation, or a melt bond, without adhesive.

Suitably, the permeation-barrier and the internal pressure sheath are at least partially bonded to one another.

Suitably, the permeation-barrier includes a fluid impermeable material. That is, the helically wound tape or the film of the permeation-barrier includes a fluid impermeable material. The permeation-barrier thereby reduces permeation of fluid to the pipe annulus. Particularly, transmission of fluid through the permeation-barrier is thereby reduced.

Suitably, the permeation-barrier includes a metal and, preferably, wherein the metal includes stainless steel or an alloy including at least one of nickel, titanium, aluminium, zinc, copper, tin, or silver.

Suitably, the permeation-barrier includes a low permeation polymer and, preferably, wherein the low permeation polymer includes at least one of PFA, PEEK, PEKK, PTFE, polyketone, ethylene-vinyl alcohol copolymer, polyethylene, polypropylene, PVDF, or PPS. Suitably, the permeation-barrier includes ethylene-vinyl alcohol copolymer provided as a co-extruded tape. More suitably, the co-extruded tape includes at least three layers including the ethylene-vinyl alcohol copolymer sandwiched between sub-layers of at least one thermoplastic polymer.

Suitably, the low permeation polymer includes a filler material.

Suitably, the filler material includes particles or fibres. More suitably, the filler material includes at least one of an oxide, a silicate, a carbonate, a carbon, a glass, or a basalt.

Suitably, the plurality of fibres of the composite tape layer are continuous fibres. More suitably, the continuous fibres are aligned in the longitudinal direction of the composite tape.

Fibres may be long or short in order to optimise or utilise their strength in one or many directions in the composite material. Long, continuous fibres are typically taken as being primarily orientated in one particular direction in order to provide strength to the composite in that orientation.

Suitably, the plurality of fibres in the composite tape layer include one or more of carbon fibres, glass fibres, basalt fibres, aramid fibres, tensilized polymer fibres, or metal wires.

Suitably, the composite tape layer includes a plurality of sub-layers.

Suitably, the composite tape layer includes at least one composite tape, wherein the composite tape has a thickness of less than 1 mm, suitably a thickness of less than 0.5 mm, and more suitably a thickness of less than 0.25 mm. In this way, the composite tape provides an effective permeation-barrier while being thin i.e. not thick enough to contribute substantially to hoop strength of the flexible pipe body. Flexibility of the pipe is maintained.

### Suitably, the Composite Tape Layer Has a Thickness of Less Than 5mm, and Suitably a

thickness of less than 2 mm.

Suitably, the composite tape layer has thickness relative to the metallic armour layer of less 50%, suitably of less than 30%, and, more suitably, of less than 15%.

According to another aspect, there is provided a flexible riser including a flexible pipe body as disclosed herein.

According to a further aspect, there is provided a method of manufacturing a flexible pipe body, the method including:
providing an internal pressure sheath,
providing a permeation-barrier layer for reducing fluid permeation;
providing a composite tape layer including a plurality of fibres; and
providing a metallic armour layer radially outward of the permeation-barrier layer and composite tape layer, such that the composite tape layer is between the permeation-barrier layer and the metallic armour layer.

Suitably, the step of providing the permeation-barrier layer includes winding a helically wound tape onto the flexible pipe body at a lay angle relative to an axis of the flexible pipe body of between greater than 20° and less than 80°. In this way, the method ensures that the resultant flexible pipe body is able to flex without risk of damage to the permeation-barrier layer.

Suitably, the step of providing the composite tape layer includes winding the composite tape onto the flexible pipe body at a lay angle relative to an axis of the flexible pipe body of greater than 20° and less than 80°. In this way, the method ensures the resultant flexible pipe body is able to flex without risk of damage to the composite tape layer, and thereby the permeation-barrier layer.

Suitably, the lay angle of the helically wound tape of the permeation-barrier layer is different to the lay angle of the composite tape of the composite tape layer.

Unless otherwise explicitly stated all features of the invention are considered combinable with one another.

Certain examples provide the advantage that a flexible pipe body with reduced permeation of undesirable fluids into the pipe annulus may be provided. Permeation by transmission is particularly reduced. The resulting annulus environment may therefore be less severe than a conventional flexible pipe, which can result in increased pipe longevity.

Certain examples provide support to the permeation-barrier. Permeation of the undesirable fluids, particularly via transmission, from the production fluids to the pipe annulus is thereby reduced or even prevented. Permeation is prevented while ensuring reliability and integrity of the permeation-barrier.

Certain examples provide optimal support and wear resistance.

Certain examples provide a more adaptable layer arrangement in a flexible pipe body. In particular, the permeation-barrier as well as the accompanying composite tape layers may be more specifically tailored to the intended use of the flexible pipe.

### BRIEF DESCRIPTION OF DRAWINGS

Embodiments of the invention are further described hereinafter with reference to the accompanying drawings, in which:

FIG. 1 illustrates a flexible pipe body;

FIG. 2 illustrates a riser system;

FIG. 3 illustrates (a) a cross-sectional view and (b) an enlarged cross-sectional view of an example layer arrangement of a flexible pipe body;

FIG. 4 illustrates (a) a known example of composite tape layers wound around an internal pressure sheath at a lay angle α and (b) an example lay angle β of a layer according to the present invention;

FIG. 5 illustrates a cross-sectional view of a layer and corresponding sub-layers of an example arrangement of a flexible pipe body;

FIG. 6 illustrates a top view of an example winding arrangement of the sub-layers of FIG. 5;

FIG. 7 illustrates a cross-sectional view of another example layer arrangement of a flexible pipe body;

FIG. 8 illustrates a flow chart of a method of manufacturing a flexible pipe body; and

FIG. 9 illustrates a flow chart of another method of manufacturing a flexible pipe body.

In the drawings like reference numerals refer to like parts.

### DETAILED DESCRIPTION

Certain terminology is used in the following description for convenience only and is not limiting. The words ‘inner’, ‘inwardly’ and ‘outer’, ‘outwardly’ refer to directions toward and away from, respectively, a designated centreline or a geometric centre of an element being described (e.g. central axis), the particular meaning being readily apparent from the context of the description.

Further, unless otherwise specified, the use of ordinal adjectives, such as, ‘first’, ‘second’, etc. merely indicate that different instances of like objects are being referred to and are not intended to imply that the objects so described must be in a given sequence, either temporally, spatially, in ranking or in any other manner.

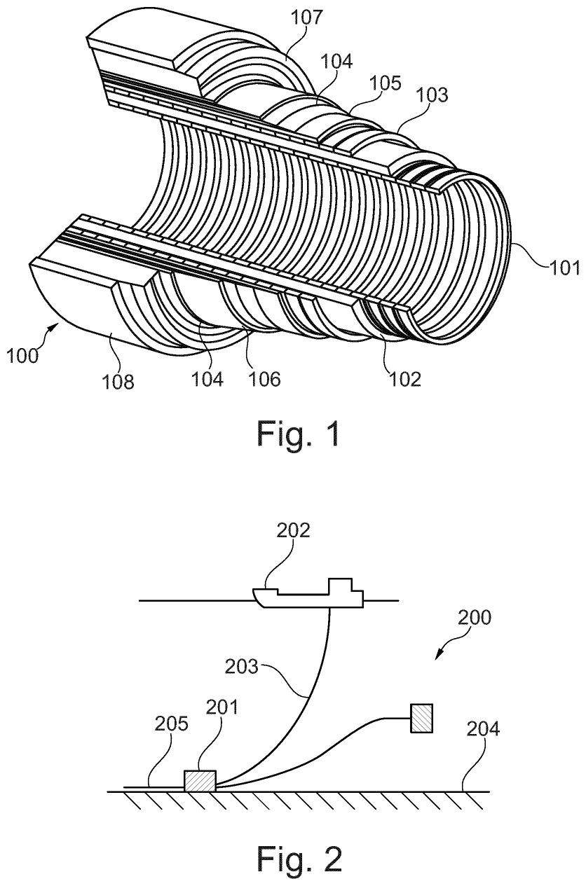

Throughout this description, reference will be made to a flexible pipe. It will be understood that a flexible pipe is an assembly of a portion of flexible pipe body and one or more end fittings in each of which a respective end of the flexible pipe body is terminated. FIG. 1 illustrates how flexible pipe body 100 is formed in accordance with an example from a combination of layered materials that form a pressure-containing conduit. Although a number of particular layers are illustrated in FIG. 1, it is to be understood that the flexible pipe body is broadly applicable to coaxial structures including two or more layers manufactured from a variety of possible materials. For example, the flexible pipe body may be formed from polymer layers, metallic layers, composite layers, or a combination of different materials. It is to be further noted that the layer thicknesses are shown for illustrative purposes only.

While some layers of the flexible pipe body may be described as bonded or consolidated the flexible pipe may generally be considered an unbonded flexible pipe. That is, unless otherwise specified the various layers of the flexible pipe body are unbonded and thereby have the capacity to move longitudinally in relation to the adjacent layers during the bending or flexion of the flexible pipe body.

As used herein, layers may optionally include sublayers. A plurality of sublayers cooperate to form a layer with a specific purpose. For example, a pressure armour layer may be formed of one or more pressure armour sub-layers.

As used herein, a composite refers to a material that is formed from two or more different materials, for example a material formed from a matrix material and reinforcement fibres. In some examples, a composite may be a composite tape layer. In other examples a composite may include an extruded layer. Fibres within a composite material may include any of carbon fibres, glass fibres, aramid fibres, basalt fibres, tensilized polymer fibres, metal wires, or any combination thereof.

As used herein, a tape is to be broadly construed as encompassing any elongate structure having a preformed cross section that can be wound in a helical manner around an underlying structure. Thus, a tape refers to an elongate material provided in a wrapable or windable form, so as to form a layer by wrapping or winding around a radially inward layer of the flexible pipe body. For example, a composite tape is a wrapable or windable elongate composite material which is used to form a composite tape layer.

As used herein the term lay angle refers to the angle at which a tape or layer is applied to, that is wrapped around, an underlying structure of the flexible pipe body. The lay angle is thereby an angle relative to the longitudinal axis of the flexible pipe body. A tape with lay angle of 90° would be a tape wrapped around a radius of a cross-section of the flexible pipe body.

It will be understood that the term radially is used to refer to a position in relation to the radius of the flexible pipe body. For example, the term radially inward is intended to refer to a position which is relatively closer to the centre, or central longitudinal axis, of the flexible pipe body and radially outward is intended to refer to a position which is relatively more distant from the centre, or central longitudinal axis, of the flexible pipe body.

Referring now to FIG. 1, a traditional layer arrangement of flexible pipe body 100 is illustrated. In this example the flexible pipe body 100 includes an optional innermost carcass layer 101. The carcass layer 101 provides an interlocked construction that can be used as the innermost layer to prevent, totally or partially, collapse of an internal pressure sheath 102 due to pipe decompression, external pressure, and tensile armour pressure and mechanical crushing loads. The carcass layer 101 is often a metallic layer, formed from stainless steel, for example. The carcass layer could 101 also be formed from composite, polymer, or other material, or a combination of materials. It will be appreciated that certain embodiments are applicable to ‘smooth bore’ operations (i.e. without a carcass layer) as well as such ‘rough bore’ applications (with a carcass layer).

The internal pressure sheath 102 acts as a fluid retaining layer and includes a polymer layer that ensures internal fluid integrity. It is to be understood that this layer may itself comprise a number of sub-layers. It will be appreciated that when the optional carcass layer 101 is utilised the internal pressure sheath 102 is often referred to by those skilled in the art as a barrier layer. In operation without such a carcass layer 101 (so-called smooth bore operation) the internal pressure sheath 102 may be referred to as a liner.

An optional sacrificial or wear layer (not shown) may also added, as an extruded layer or helically wound tape layer, either or both radially inwardly or radially outwardly of the internal pressure sheath; these layers respectively provide a relatively smooth (compared to the outside surface of the carcass layer) surface over which to extrude the internal pressure sheath, or provide a sacrificial layer of material which may, under pressure, be creep into the gaps between wraps of an overlying metallic armour layer, particularly a pressure armour layer.

An optional pressure armour layer 103 is provided radial outward of the internal pressure sheath 102. The pressure armour layer 103 is a structural layer that increases the resistance of the flexible pipe to internal and external pressure and mechanical crushing loads. That is, the pressure armour layer 103 sustains radial loads. The pressure armour layer 103 specifically provides hoop strength to the flexible pipe body 100.

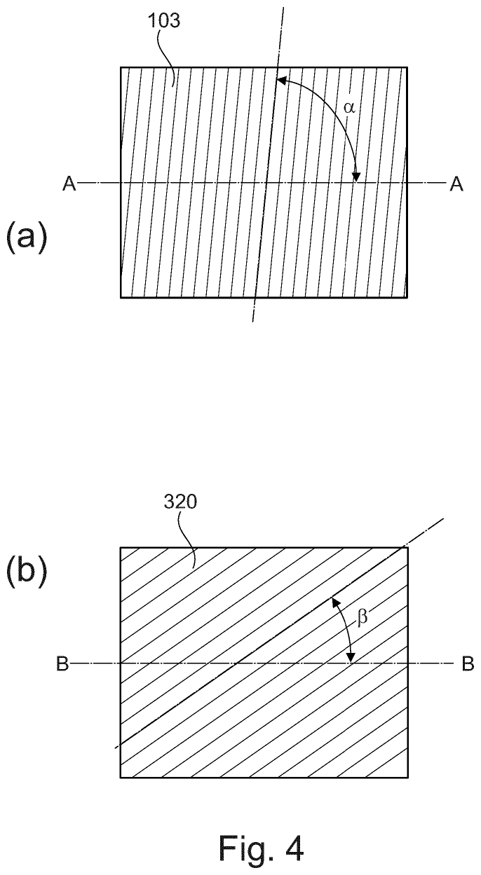

The pressure armour layer 103 also structurally supports the internal pressure sheath 102. Referring additionally to FIG. 4(a), the pressure armour layer 103 is formed from an interlocked construction of wires wound with a lay angle α relative to a flexible pipe body axis A-A. The lay angle α is typically close to 90°. In this way laterally adjacent interlocking wires provide a rigid pressure armour layer 103 that provides maximal hoop strength to the entire flexible pipe body 100.

The flexible pipe body 100 as shown includes sub-layers including a first tensile armour layer 105 and second tensile armour layer 106. Each tensile armour layer is used to sustain tensile loads and internal pressure and are wound at angles around the pipe body optimised to achieve the desired balance of tensile and pressure containment. For instance the lay angle of the tensile armour wires may be around +/−55° when no pressure armour wire is used in the design (and the tensile armours must withstand both pressure and tension forces), however their lay angles may be much lower, for instance as low as 27°-30° when a pressure armour is incorporated and the tensile armours are primarily intended to sustain tensile loads. Each tensile armour layer is formed from a plurality of wires (to impart strength to the layer) that are located over an inner layer and are helically wound along the length of the pipe. The tensile armour layers are often counter-wound in pairs. The tensile armour layers are often metallic layers, formed from carbon steel, for example.

The flexible pipe body 100 shown also includes optional tape layers 104 provided radially outward of the tensile armour layers 105, 106, which help contain underlying layers and extent prevent abrasion between adjacent layers.

The flexible pipe body 100 also typically includes optional layers of insulation 107 and an outer sheath 108, which includes a polymer layer used to protect the pipe against penetration of seawater and other external environments, corrosion, abrasion and mechanical damage. Further layers (not shown) may also be added radially outside the outer sheath 108 to provide additional wear/abrasion protection to the pipe and to prevent damage from occurring to the outer sheath 108.

Each flexible pipe 100 includes at least one portion, sometimes referred to as a segment or section of flexible pipe body 100 together with an end fitting located at at least one end of the flexible pipe. An end fitting provides a mechanical device which forms the transition between the flexible pipe body and a connector. The different pipe layers as shown, for example, in FIG. 1 are terminated in the end fitting in such a way as to transfer the load between the flexible pipe body and the connector.

Referring now to FIG. 2, there is shown a known riser assembly 200 suitable for transporting production fluid such as oil and/or gas and/or water from a sub-sea location 201 to a floating facility. For example, in FIG. 2 the sub-sea location 201 includes a sub-sea flow line. The flexible flow line 205 includes a flexible pipe 203, wholly or in part, resting on the sea floor 204 or buried below the sea floor and used in a static application. The floating facility may be provided by a platform and/or buoy or, as illustrated in FIG. 2, a ship 200. The riser assembly 200 is provided as a flexible riser, that is to say a flexible pipe 203 connecting the ship to the sea floor installation. The flexible pipe 203 may be in segments of flexible pipe body with connecting end fittings.

It will be appreciated that there are different types of riser, as is well-known by those skilled in the art. Embodiments may be used with any type of riser, such as a freely suspended (free, catenary riser), a riser restrained to some extent (buoys, chains), totally restrained riser or enclosed in a tube (I or J tubes). FIG. 2 also illustrates how portions of flexible pipe body can be utilised as a flow line 205 or jumper.

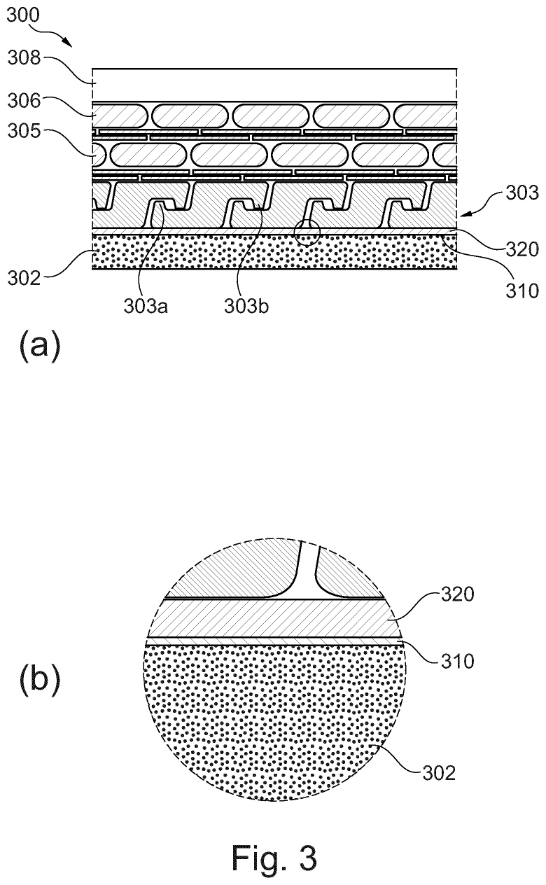

Referring now to FIG. 3(a) and 3(b), an example layer arrangement of a flexible pipe body 300 is shown in cross-section. In this example, the flexible pipe body 300 includes an internal pressure sheath 302. The internal pressure sheath 302 defines the flexible pipe bore. In some examples a carcass layer (not shown) may be provided radially inward of the internal pressure sheath 302 to define the pipe bore.

Tape layers (not shown), tensile armour layers 305, 306 and an outer sheath 308 are provided in the radially outer portion of the flexible pipe body 300. These layers are described above with reference to FIG. 1 and so will not be described again for brevity. Although not illustrated one or more insulating layers, and/or abrasion layers, as is known in the art, may also be included in the flexible pipe body 300.

In the example shown, the flexible pipe body 300 in this example includes a metallic pressure armour layer 303. The pressure armour layer 303 is a helically wound pressure layer, typically formed of carbon steel. The metallic pressure armour layer 303 is positioned radially outward of a permeation-barrier 310.

The metallic armour layer 303 includes one or more metallic armour tape. The metallic armour tapes are helically wrapped or wound radially outward of the permeation-barrier 310. In the example shown, successive wraps of the metallic pressure armour tape are wrapped directly around a composite tape layer 320 to provide a region of overlap between laterally adjacent tape wraps. It will be understood that a sacrificial or wear layer may be introduced between the composite layer and the metallic armour layer. Such a sacrificial or wear layer may comprise a tape or extruded polymer, as is known in the art.

The metallic armour layer 303 has an interlocked construction (a Z shaped profile). Each metallic armour wire includes opposing longitudinal edges 303a, 303b including mutually engaging features, as is known in the art. In this way, laterally adjacent tape wraps of the metallic armour layer 303 interlock in the region of overlap between laterally longitudinal edges. In this way, the metallic armour layer 303 predominantly provides the hoop strength for the flexible pipe body 300. The metallic armour layer 303 sustains the radial loads on the flexible pipe body 300.

The metallic armour layer 303 is provided radially outward of the internal pressure sheath 302.

It will be understood that for pipes of design where no interlocked metallic pressure armour is needed, and metallic tensile armours provide both pressure and tension reinforcement for the pipe, the pressure armour layer 303 shown in FIG. 3 may be omitted. In such designs the tensile armours are a metallic armour layer.

The flexible pipe body 300 includes a permeation-barrier layer 310 positioned radially inward of the metallic armour layer 303. In the example shown, the permeation-barrier layer 310 is provided between the internal pressure sheath 302 and the metallic armour layer 303. The internal pressure sheath 302 is positioned radially inwards of the permeation-barrier layer 310.

The permeation-barrier layer 310 reduces fluid permeation through the flexible pipe body 300 by virtue of the features described herein. Permeation of the undesirable fluids from the production fluids to the pipe annulus is thereby prevented or reduced.

In the example shown, the permeation-barrier 310 is a tape, film or foil. Advantageously, the film or foil ensures that the permeation-barrier layer 310 is a continuous permeation-barrier layer (all edges of permeation-barrier tapes are covered by further permeation-barrier tape sections or wraps, optionally bonded to each other) thereby providing a continuous permeation-barrier along the flexible pipe body 300. In particular, the permeation-barrier is a metal tape, film or foil providing a fluid impermeable layer along the flexible pipe body 300. Permeation of the undesirable fluids from the production fluids to the pipe annulus, and specifically to the metallic armour layers, particularly via transmission, is thereby further reduced or even prevented.

By providing a flexible pipe body with a permeation-barrier of continuous construction, the internal pressure sheath is thereby surrounded by a sleeve without gaps or discontinuities, even when the flexible pipe body bends. Permeation of undesirable fluids by leakage to the pipe annulus is reduced or even prevented. Furthermore, the internal pressure sheath is thereby surrounded by a sleeve of a substantially fluid impermeable material such that transmission of fluid is substantially reduced. The resulting annulus environment may therefore be less severe, for example less corrosive, than a conventional flexible pipe, increasing pipe longevity.

Application of the permeation-barrier layer may be achieved by helical winding of the tape, film or foil with at least partial overlap of adjacent helical windings or overlaying windings, or by applying the film or foil in longitudinally orientated with respect to the pipe axis, with the width of the film or foil being wrapped circumferentially around the pipe, or by other suitable means, such as spray application or vapor deposition.

The flexible pipe body 300 further includes a composite tape layer 320. The composite tape layer 320 is configured to support the permeation-barrier 310 thereby improving the reliability and integrity of the permeation-barrier 310. The composite tape layer 320 is a thin composite tape layer 320, as described herein, so as to provide support and wear resistance in a convenient and adaptable manner.

The composite tape layer 320 includes a helically wound composite tape. The helically wound composite tape is wrapped or wound around the permeation-barrier 310 to form the composite tape layer 320. Successive tape wraps of the helically wound composite tape are wound around the permeation-barrier to provide a series of laterally adjacent tape wraps. The overlaps may therefore reduce permeation of fluids through the composite tape layer 320 by reducing or removing gaps between adjacent tape wraps which could otherwise provide leakage paths.

The helically wound composite tape includes two surfaces and a first longitudinal edge and a second longitudinal edge. The first and second longitudinal edges are mutually opposed edges extending in the longitudinal direction of the helically wound composite tape. Thus, with the helically wound composite tape wound around the permeation-barrier 310, a first longitudinal edge of a first tape wrap abuts, or overlaps, a second longitudinal edge of laterally adjacent second tape wrap.

The composite tape of the composite tape layer 320 is helically wound with a lay angle relative to an axis of the flexible pipe body 300. Referring additionally, to FIG. 4(b), in the example shown, the composite tape layer 320 is helically wound with a layer angle β relative to the axis B-B of the flexible pipe body 300. In the example shown the lay angle β is 40°. The lay angle therefore provides a reduced minimum bending radius of the composite tape layer 320. Consequently, the lower minimum bending radius allows for greater flexibility of the flexible pipe body 300.

The composite tape layer 320 includes a plurality of fibres. The plurality of fibres in the composite tape of the composite tape layer 310 are predominantly or exclusively continuous fibres. The continuous fibres are aligned in the length direction of the composite tape. That is, the continuous fibres are aligned longitudinally within the composite tape. The composite tapes are helically wound around the underlying layer, in this case the internal pressure sheath 302. With the composite tape wound around the internal pressure sheath 302 the continuous fibres of the composite have a lay angle substantially the same as the lay angle β of the composite tape layer 310.

The composite tape layer 320 is configured to cover the region of overlap between laterally adjacent tape wraps of a metallic armour layer 303. The composite tape of the composite layer 320 thereby extends between a first longitudinal edge of a first tape wrap and a second longitudinal edge of laterally adjacent second tape wrap. In this way, the composite tape layer 320 covers unevenness or gaps which extend between laterally adjacent tape wraps of the metallic armour layer 303.

Advantageously, the composite tape layer 320 is deformable to the unevenness of the metallic armour layer 303. In particular, the composite tape layer 320 is deformable towards the interstitial space between laterally adjacent tape wraps of the metallic armour layer 303. Interfacial pressure during use of the flexible pipe body thereby causes the composite tape layer 320 to adapt to any unevenness in the metallic armour layer protecting the integrity of the permeation-barrier 310.

In the example shown, the composite tape layer 320 and the permeation-barrier 310 are bonded to one another. Essentially, the permeation-barrier 310 and composite tape layer 320 is provided as a metal film with a composite tape layer backing. Thus, the mutually adjacent surfaces of the composite tape layer 320 and the permeation-barrier 310 are bonded to limit relative longitudinal movement therebetween.

In use, a flexible pipe body 300 including the example composite tape layer 320 and permeation-barrier 310 described above may be provided with suitable connectors to enable the flexible pipe body 300 to form a flexible pipe for transporting production fluid, such as described with reference to FIG. 2. By providing a layer arrangement as described with reference to FIG. 3, a flexible pipe body with reduced permeation of undesirable fluids to the pipe annulus may be provided. A flexible pipe body with a more resilient permeation-barrier may be provided.

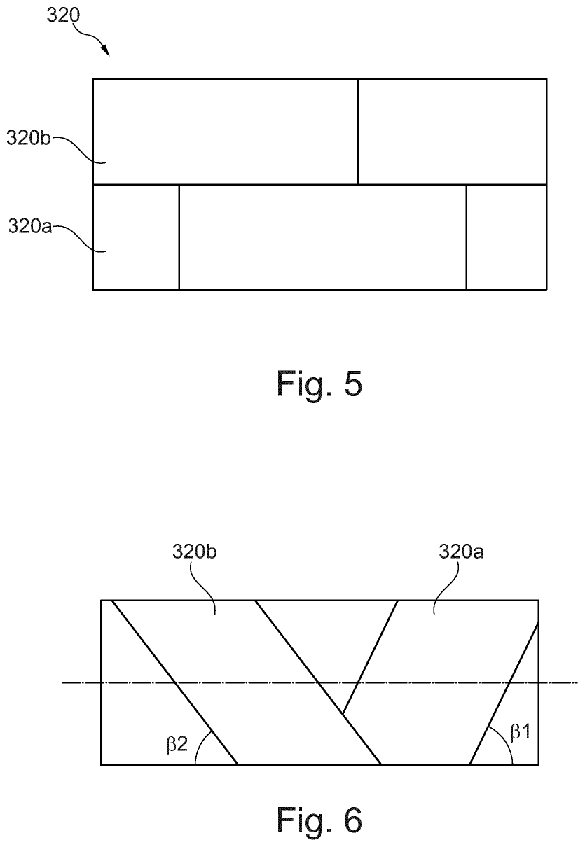

Referring additionally to FIGS. 5 and 6, there are shown close-up views of the composite tape layer 320. The composite tape layer 320 includes a first sub-layer 320a of composite tape and a second sub-layer 320b of composite tape. The first sub-layer 320a is provided radially inward of the second sub-layer 320b.

In the example shown, the first sub-layer 320a is consolidated with the second sub-layer 320b. In this way the sub-layers are substantially bonded together to form a single composite tape layer 320. The sub-layers thereby function collectively as a composite tape layer 320 to support and protect the integrity of the permeation-barrier 310, as is described herein.

The composite tapes of each of the first sub-layer 320a and the second sub-layer 320b have the properties of the composite tape as described herein. One or more properties of the composite tape of the first sub-layer 320a may be different to one or more corresponding property of the second sub-layer 320b.

The first sub-layer 320a is wound at a first lay angle β1 to the axis of the flexible pipe body 300. The second sub-layer 320b is counter wound at a second lay angle β2 to the axis of the flexible pipe body 300. In this way permeation of fluids through the composite tape layer 320 is reduced by removing gaps, or discontinuities between successive wraps of composite tape sub-layers 320a, 320b that may otherwise provide leakage pathways.

Advantageously, by forming the composite tape layer 320 from two sub-layers 320a, 320b a greater number of options for design and manufacture of the flexible pipe body 300 is provided. The consolidation of sub-layers provides the ability to adapt the composite tape layer 320 depending on specific support or deformability requirements of the permeation-barrier. For example, a first sub-layer may preferentially block permeation, that is transmission, of a first production fluid, and a second sub-layer may preferentially block permeation, that is transmission, of a second production fluid. The composite tape layer is thereby adaptable in light of the production fluids contained within the flexible pipe body 300.

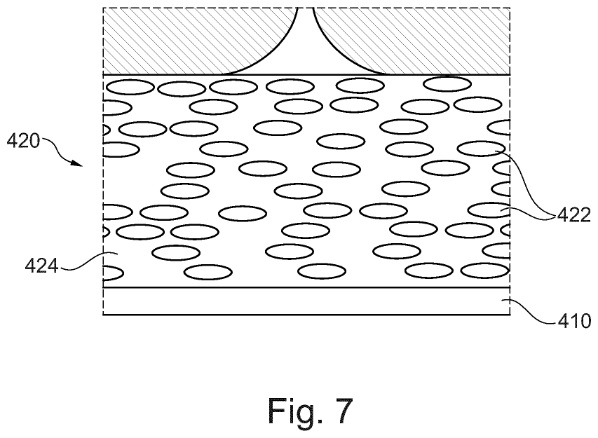

Referring now to FIG. 7, there is shown a schematic example of a composite tape layer 420, such as the composite tape layer provided in the flexible pipe body described with reference to FIG. 3. The composite tape layer 420 includes a plurality of fibres 422 within a matrix 424. Each fibre 422 is embedded in the matrix 424.

The plurality of fibres 422 are aligned in the longitudinal direction of the composite tape. Thus, the fibres 422 extend helically when the composite tape is helically wound around an underlying layer.

In the example shown, the composite tape has a thickness of 0.22 mm. In certain examples, a series of such helically wound composite tapes are provided in a flexible pipe body. Each composite tape provides a sub-layer of a composite tape layer 420 such that a composite tape layer is provided of greater thickness than the composite tape. For example, the composite tape layer may have a thickness of 3 mm or more.

Advantageously, the composite tape layer 420 is sufficient deformable in response to pressure within the flexible pipe body. In particular, the composite tape layer 420 is deformable relative to the unevenness of a radially outward metallic armour layer. For example, the composite tape layer 420 is deformable towards the interstitial space between laterally adjacent tape wraps of the metallic armour layer. Interfacial pressure during use of the flexible pipe body thereby causes the composite tape layer 420 to adapt to the unevenness in the metallic armour layer protecting the integrity of the radially adjacent permeation-barrier.

Advantageously, the matrix 424 of the composite tape layer 420 also comprises nanoparticles to further increase the tortuosity of the permeation path that undesirable fluids must navigate to pass through the composite tape layer, and consequently reduce the permeability of the layer further.

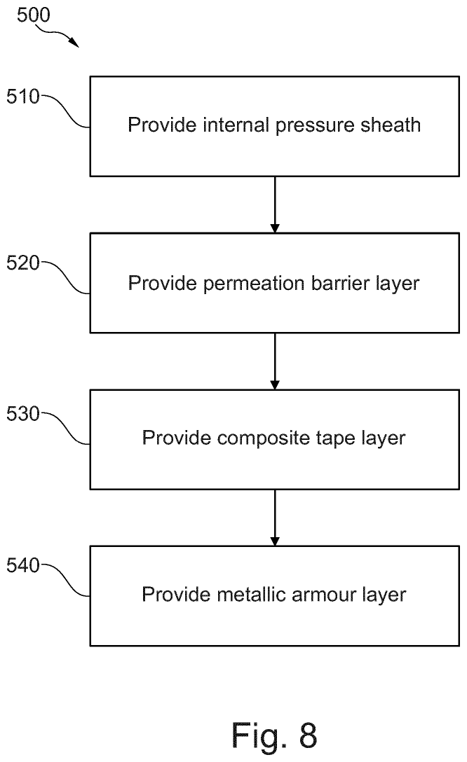

Referring now to FIG. 8, there is shown a flow chart illustrating a method 500 of manufacturing a flexible pipe body, such as those described herein. The method may be carried out using any suitable choice of operation such as mechanically or manually winding the layers.

A first step 510 includes providing an internal pressure sheath for the flexible pipe body, optionally over a carcass layer (not shown). Suitably, the internal pressure sheath is formed by an extrusion process as is known in the art.

A second step 520 includes providing a permeation-barrier layer. The permeation-barrier layer is suitable for reducing fluid permeation through the flexible pipe body. Optionally, the method provides a permeation-barrier layer, formed from a helically wound tape, film or foil, or at least one axially orientated film or foil, radially outward of the internal pressure sheath. Successive tape wraps of the helically wound tape may be wound around the internal pressure sheath to provide a series of laterally adjacent tape wraps.

Optionally, laterally adjacent tape wraps of the helically wound tape are joined via a connection portion. The laterally adjacent tape wraps are joined using a bonding process so that the connection portion forms a portion of the continuous metallic permeation-barrier layer. The connection portion forms a bond between laterally adjacent tape wraps. In an example method, the join is a weld bond.

Advantageously, the bonding process ensures that the permeation-barrier layer is a continuous permeation-barrier layer thereby providing a continuous permeation-barrier along the flexible pipe body. In particular, the barrier is a continuous barrier of metal. Permeation, particularly via transmission, of undesirable fluids from the production fluids to the pipe annulus is thereby prevented or at least reduced.

In an example, the method uses a bonding process to join a first longitudinal edge of a first helical tape wrap a second longitudinal edge of a second tape wrap. The bonding process thereby provides a connection portion which extends around the circumference of the flexible pipe body. The bonding process thereby provides a connection portion that coextends between first and second opposing longitudinal edges of adjacent tape wraps of the helically wound tape on the flexible pipe body. In this way, the bonding process, for example a welding process, follows the pitch of the helically wound tape. Similarly a bonding process may be applied to the longitudinal edges of an axially applied film or foil to ensure continuity of the permeation-barrier layer around the circumference of the pipe. Bonding may also be achieved through the application of heat and/or pressure to overlapping portions of tape, film or foil.

A third step 530 includes providing a composite tape layer. The composite tape layer is wound onto the flexible pipe body. Optionally, the composite tape layer may be provided on the flexible pipe body as a plurality of sub-layers which overlap with one another. In this way, first and second sub-layers are wound sequentially onto the flexible pipe body.

A fourth step 540 includes providing a metallic armour layer radially outward of the composite tape layer. Typically, the metallic armour layer is provided helically winding a suitable tape onto an underlying layer. In this way, the method provides the metallic armour layer to predominantly provide the hoop strength for the flexible pipe body.

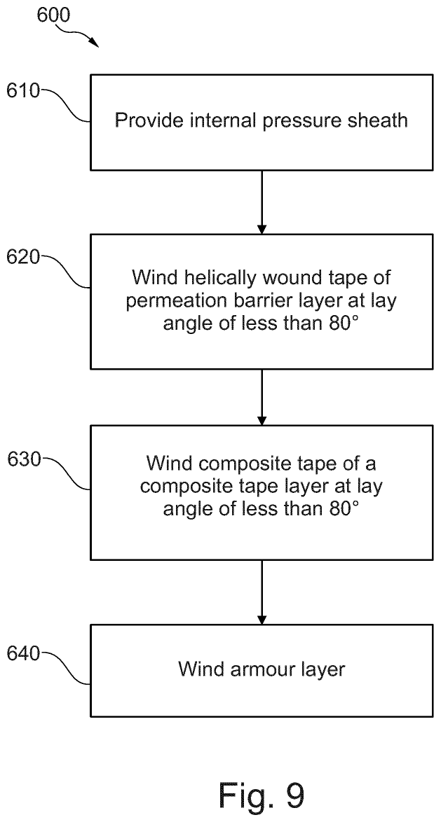

Referring now to FIG. 9, there is shown a flow chart illustrating another method 600 of manufacturing a flexible pipe body, such as those described herein. The method may be carried out using any suitable choice of operation such as mechanically or manually winding the layers.

The method 600 is substantially the same as the method described with reference to FIG. 8, other than the permeation-barrier layer and the composite tape layer each have a lay angle relative to an axis of the flexible pipe body of less than 80°.

Thus, a first step 610 includes providing an internal pressure sheath for the flexible pipe body. Suitably, the internal pressure sheath is formed by an extrusion process as is known in the art.

A second step 620 includes providing a permeation-barrier layer. The permeation-barrier layer is suitable for reducing fluid permeation through the flexible pipe body. The method provides a permeation-barrier layer, formed from a helically wound tape, film or foil, or a longitudinally orientated film or foil, radially outward of the internal pressure sheath. The tape, film or foil of the permeation-barrier may be provided by winding the helically wound tape onto the underlying layer of the flexible pipe body at a lay angle relative to an axis of the flexible pipe body of less than 80°. Typically, the lay angle is in a range from greater than 20° to less than 80°. One or more longitudinally orientated films or foils may be wrapped around an underlying pipe layer ensuring overlap of the longitudinal edges of the film or foil to ensure continuity of the permeation-barrier layer around the circumference of the pipe. A third step 630 includes providing a composite tape layer. The composite tape layer is wound onto the flexible pipe body at a lay angle relative to the flexible pipe body axis of less than 80°. In this way the structure of the composite tape layer will be flexible. Typically, the lay angle is in a range from greater than 20° to less than 80°.

A fourth step 640 includes providing a metallic armour layer radially outward of the composite tape layer. Suitably, the metallic armour layer is provided and arranged according any of the example metallic armour layers described herein. For example, the metallic armour layer may be provided by helically winding a metallic pressure armour wire onto an underlying layer. In this way, the method provides the metallic armour layer to predominantly provide the hoop strength for the flexible pipe body.

It will be understood that the addition of other layers into the pipe structure is permissible. For instance, a sacrificial or wear layer may be introduced between a composite tape layer and an overlying metallic armour layer.

It will also be understood that the permeation-barrier layer may be applied over a sacrificial or wear layer which overlies an inner carcass. In this instance the structure provided could feature the permeation-barrier layer and composite tape layer radially inside the internal pressure sheath. Alternatively, the structure provided could feature the permeation-barrier layer and composite tape layer separated by the internal pressure sheath and radially inside an overlying metallic armour layer.

Various modifications to the detailed arrangements as described above are possible.

In certain examples, the permeation-barrier layer of a flexible pipe body may include a helically wound tape. The tape is a barrier tape. The helically wound tape may be a helically wound metallic tape. The helically wound tape is wrapped or wound around the internal pressure sheath to form the permeation-barrier layer. Successive tape wraps of the helically wound tape are wound around the internal pressure sheath to provide a series

The helically wound tape of the permeation-barrier layer may include a first longitudinal edge and a second longitudinal edge. The first and second longitudinal edges are mutually opposed edges extending in the elongate direction of the helically wound tape. Thus, with the helically wound tape wound around the internal pressure sheath a first longitudinal edge of a first tape wrap abuts, or overlaps, a second longitudinal edge of laterally adjacent second tape wrap.

The permeation-barrier layer may include a connection portion configured to join laterally adjacent tape wraps of the helically wound tape. The connection portion forms a bond between laterally adjacent tape wraps. Typically, the connection portion is a weld bond. Advantageously, the bond ensures that the permeation-barrier layer is a continuous permeation-barrier layer thereby providing a continuous permeation-barrier along the flexible pipe body. Permeation of the undesirable fluids from the production fluids to the pipe annulus is thereby further reduced or even prevented.

The connection portion forms a weld bond between the abutting first longitudinal edge of the first tape wrap and the second longitudinal edge of the second tape wrap.

Alternatively, the helically wound tape of the permeation-barrier may be wrapped so as to provide a region of overlap between laterally adjacent tape wraps. In this way, a connection portion may form a weld bond between the first longitudinal edge of the first tape wrap and a surface portion of the second tape wrap. The surface portion of the second tape wrap may be either an inner surface portion or an outer surface portion of the second tape wrap.

Regardless of whether the connection portion joins abutting or overlap tape wraps, the connection portion may extend around the circumference of the flexible pipe body. The connection portion may coextend between abutting first and second longitudinal edges of adjacent tape wraps of the helically wound tape on the flexible pipe body. Alternatively, the connection portion coextends with the overlapping first longitudinal edge of a tape wrap of the helically wound tape. In these ways, the connection portion forms a bond following the pitch of the helically wound tape.

The permeation-barrier may thereby include a lay angle relative to an axis of the flexible pipe body.

In certain examples, the composite tape layer and the permeation-barrier may be at least partially bonded to one another using an adhesive. Alternatively, the composite tape layer and the permeation-barrier may be at least partially bonded to one another using a melt consolidation, or a melt bond, without adhesive.

In certain examples, the permeation-barrier and the internal pressure sheath may be at least partially bonded to one another.

It will be clear to a person skilled in the art that features described in relation to any of the embodiments described above can be applicable interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise. It will be also be appreciated that, throughout this specification, language in the general form of “X for Y” (where Y is some action, activity or step and X is some means for carrying out that action, activity or step) encompasses means X adapted or arranged specifically, but not exclusively, to do Y.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1: A flexible pipe body for transporting production fluids, the flexible pipe body comprising:
an internal pressure sheath;
a permeation-barrier for reducing fluid permeation of the production fluids towards a pipe annulus;
a metallic armour layer positioned radially outward of the permeation-barrier; and
a composite tape layer comprising a plurality of fibres, wherein the composite tape layer is positioned radially between the permeation-barrier and the metallic armour layer.

2: The flexible pipe body according claim 1, wherein the permeation-barrier comprises a helically wound tape or a film or a foil.

3: The flexible pipe body according to claim 2, wherein the helically wound tape comprises a lay angle relative to an axis of the flexible pipe body in a range from greater than 20°to less than 80°.

4: The flexible pipe body according to claim 1, wherein the helically wound tape or the film comprises a metal.

5: The flexible pipe body according claim 1, wherein the permeation-barrier comprises at least one tape, film or a foil longitudinally orientated with the axis of the flexible pipe body and wrapped around an underlying layer.

6: The flexible pipe body according to claim 1, wherein the metallic armour layer comprises at least one helically wound metallic tape having a first longitudinal edge and a second longitudinal edge, and wherein the metallic armour layer comprises a region of overlap coextending with the first longitudinal edge of a first tape wrap of the helically wound metallic tape and the second longitudinal edge of a second tape wrap.

7: The flexible pipe body according to claim 6, wherein the composite tape layer is configured to cover the region of overlap between the first and second tape wraps of a radially overlying metallic armour layer.

8: The flexible pipe body according to claim 1, wherein the metallic armour layer comprises a helically wound metallic tape with a lay angle relative to an axis of the flexible pipe body of at least 80°.

9: The flexible pipe body according to claim 1, wherein the composite tape layer comprises helically wound composite tape with a lay angle relative to the flexible pipe axis in a range from greater than 20° to less than 80°.

10: The flexible pipe body according to claim 1, wherein the composite tape layer and the permeation-barrier are at least partially bonded to one another.

11: The flexible pipe body according to claim 10, wherein the composite tape layer and the permeation-barrier are at least partially bonded to one another using an adhesive.

12: The flexible pipe body according to claim 10, wherein the composite tape layer and the permeation-barrier are at least partially bonded to one another using a melt consolidation, or a melt bond, without adhesive.

13: The flexible pipe body according to claim 1, wherein the permeation-barrier and the internal pressure sheath are at least partially bonded to one another.

14: The flexible body according to claim 1, wherein the permeation-barrier comprises a fluid impermeable material.

15: The flexible body according to claim 14, wherein the permeation-barrier comprises a metal and, preferably, wherein the metal comprises stainless steel or an alloy comprising at least one of nickel, titanium, aluminium, zinc, copper, tin, or silver.

16: The flexible body according to claim 14, wherein the permeation-barrier comprises a low permeation polymer and, preferably, wherein the low permeation polymer comprises at least one of PFA, PEEK, PEKK, PTFE, polyketone, ethylene-vinyl alcohol copolymer, polyethylene, polypropylene, PVDF, or PPS.

17: The flexible body according to claim 16, wherein the permeation-barrier comprises ethylene-vinyl alcohol copolymer provided as a co-extruded tape and, preferably, wherein the co-extruded tape comprises at least three layers including the ethylene-vinyl alcohol copolymer sandwiched between sub-layers of at least one thermoplastic polymer.

18: The flexible pipe according to claim 17, wherein the low permeation polymer comprises a filler material and, preferably, wherein the filler material comprises particles or fibres.

19: The flexible pipe body according to claim 18, wherein the filler material comprises at least one of an oxide, a silicate, a carbonate, a carbon, a glass, or a basalt.

20: The flexible pipe body according to claim 1, wherein the plurality of fibres of the composite tape layer are continuous fibres.

21: The flexible pipe body according to claim 20, wherein the continuous fibres are aligned in the longitudinal direction of the composite tape.

22: The flexible pipe body according to claim 1, wherein the plurality of fibres in the composite tape layer comprise one or more of carbon fibres, glass fibres, basalt fibres, aramid fibres, tensilized polymer fibres, or metal wires.

23: The flexible pipe body according to claim 1, wherein the composite tape layer comprises a plurality of sub-layers.

24: The flexible pipe body according to claim 1, wherein the composite tape layer comprises at least one composite tape, wherein the composite tape has a thickness of less than 1 mm, suitably a thickness of less than 0.5 mm, and more suitably a thickness of less than 0.25 mm.

25: The flexible pipe body according to claim 1, wherein the composite tape layer has a thickness of less than 5 mm, and suitably a thickness of less than 2 mm.

26: The flexible pipe according to claim 1, wherein the composite tape layer has thickness relative to the metallic armour layer of less 50%, suitably of less than 30%, and, even more suitably, of less than 15%.

27: A flexible riser comprising the flexible pipe body of claim 1.

28: A method of manufacturing a flexible pipe body, the method comprising:
providing an internal pressure sheath, providing a permeation-barrier layer for reducing fluid permeation;
providing a composite tape layer comprising a plurality of fibres; and,
providing a metallic armour layer radially outward of the permeation-barrier layer and composite tape layer, such that the composite tape layer is between the permeation-barrier layer and the metallic armour layer.

29: The method according to claim 28, wherein the step of providing the permeation barrier layer comprises winding a helically wound tape onto the flexible pipe body at a lay angle relative to an axis of the flexible pipe body of between greater than 20° and less than 80°.

30: The method according to either of claim 28, wherein the step of providing the composite tape layer comprises winding the composite tape onto the flexible pipe body at a lay angle relative to an axis of the flexible pipe body of greater than 20° and less than 80°.

31: The method according to claim 29, wherein the lay angle of the helically wound tape of the permeation-barrier layer is different to the lay angle of the composite tape of the composite tape layer.
